(19) United States
(12) Patent Application Publication
(10) Pub. No.: US 2018/0103503 A1
(43) Pub. Date: Apr. 12, 2018

(54) USING NETWORKING RELATIONSHIP IN CONFIGURING RADIO CONNECTIVITY

(71) Applicant: NOKIA SOLUTIONS AND NETWORKS OY, Espoo (FI)

(72) Inventor: Mehdi BENNIS, Oulu (FI)

(21) Appl. No.: 15/568,789

(22) PCT Filed: Apr. 24, 2015
(86) PCT No.: PCT/EP2015/058950

§ 371 Date: Oct. 23, 2017

(51) Int. Cl. H04W 76/04

(52) U.S. Cl. CPC H04W 76/14

(57) ABSTRACT

There is provided a solution for using application layer information to establish clusters in a cell of a cellular communication system. In an embodiment, there is acquired at least one information element representing application layer networking relationship of a first user account associated with a first terminal device with at least a second user account of a second terminal device. The information element may be used in connection with determining the clusters in the cellular communication system.

### FIELD OF THE INVENTION

The invention relates generally to mobile networks.

### BACKGROUND

Over the recent years, mobile communications devices have developed and new type of devices, such as smart phones, have become widely available and have substantially enriched the mobile user experience by offering new services and applications to a user. The vast array of new wireless services may include multimedia streaming, web-browsing applications and socially-interconnected networks. However, simultaneously, the amount data being transferred in the network has increased. For example, mobile video streaming already accounts for almost half of mobile data traffic, with a projection of significant increase over the next 10 years. Therefore, for the sake of user experience, solutions for making data transfer more flexible and efficient have raised increased interest.

### BRIEF DESCRIPTION OF THE INVENTION

According to an aspect of the invention, there are provided the subject matter of the independent claims.

Some embodiments of the invention are defined in the dependent claims.

### LIST OF THE DRAWINGS

In the following, the invention will be described in greater detail with reference to the embodiments and the accompanying drawings, in which

FIG. 1 illustrates an example of a radio communication network to which embodiments of the invention may be applied;

FIG. 2 shows a method for generating clusters within a cell according to an embodiment;

FIG. 3 shows a social network community operating in a radio access network, according to an embodiment;

FIG. 4 illustrates a method for transmitting application layer information according to an embodiment;

FIG. 5 illustrates generation of social tie strength values and communicating the values to a controller of a cellular communication system according to an embodiment;

FIG. 6 illustrates attributes related to the social tie strength values according to an embodiment;

FIG. 7 illustrates a signaling diagram for constructing a database representing networking relationship between users in a cell according to an embodiment;

FIG. 8 illustrates a block diagram of a method for configuring device-to-device radio connectivity in the clusters according to an embodiment;

FIG. 9 illustrates an embodiment where networking relationship and physical layer characteristics are used in determining whether or not to arrange two terminal devices to the same cluster;

FIG. 10 illustrates an embodiment where it is determined on the basis of strength of tie between two terminal devices whether or not to assign the terminal device to the same cluster; and

FIGS. 11 and 12 illustrate block diagrams of apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described herein may be implemented in a radio system, such as in at least one of the following: Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and/or 5G system. The present embodiments are not, however, limited to these protocols.

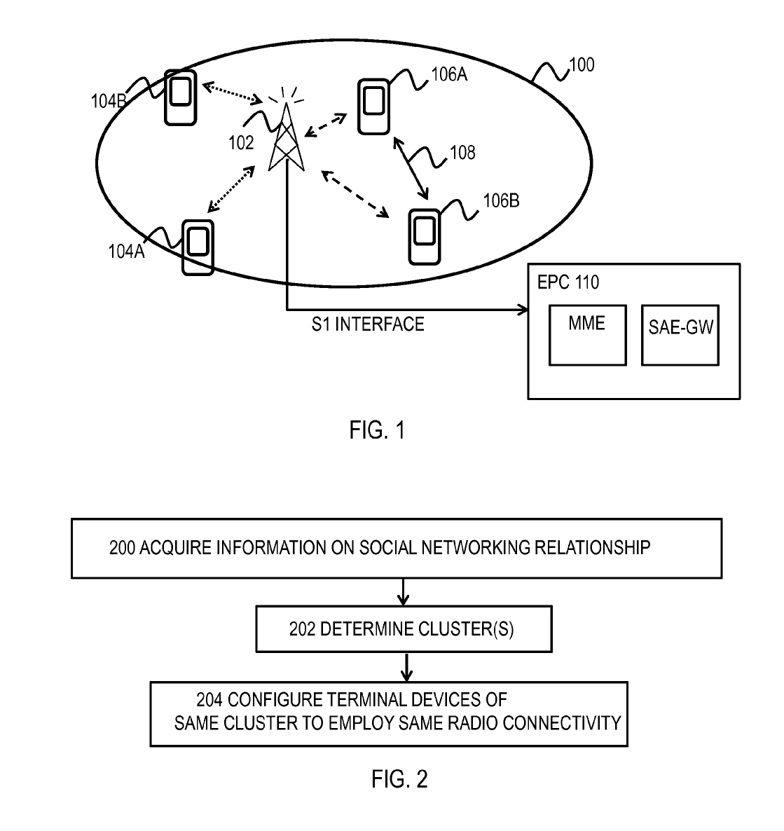

FIG. 1 shows an example communication network. Radio communication networks, such as the Long Term Evolution (LTE) or the LTE-Advanced (LTE-A) of the 3^{rd} Generation Partnership Project (3GPP), are typically composed of at least one access node 102 providing radio coverage within one or more cells 100. The access node may be a base station of a cellular communication system, for example. However, it may be another type of access node, e.g. a server computer connected to a remote radio head. It should be appreciated that future networks will may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

The access node 102 may operate a single cell 100 or a plurality of cells. Each cell may be, e.g., a macro cell, a micro cell, or a pico-cell, for example. The access node may be evolved node B (eNB) as in the LTE and LTE-A, a radio network controller (RNC) as in the UMTS, a access node controller (BSC) as in the GSM/GERAN, or any other apparatus capable of controlling radio communication and managing radio resources within a cell. In the case of multiple eNBs in the communication network, the eNBs may be connected to each other with an X2 interface as specified in the LTE. The eNB 102 may be further connected via an S1 interface to an evolved packet core (EPC) 110, more specifically to a mobility management entity (MME) and to a system architecture evolution gateway (SAE-GW).

Still referring to FIG. 1, the access node 102 may control a cellular radio communication link established between the access node 102 and terminal devices 104A and 104B located within the cell 100. These communication links marked with dotted arrows may be referred as conventional communication links for end-to-end communication, where the source device transmits data to the destination device via the access node 102 and/or a core network 110. Therefore, for example, the user terminals 104A and 104B may communicate with each other via the access node 102 and an EPC 110 representing the core network. The terminal device may be a terminal device of a cellular communication system, e.g. a computer (PC), a laptop, a palm computer, a mobile phone, or any other user terminal or user equipment capable of communicating with the cellular communication network.

In addition to or instead of conventional communication links, direct radio connections may be established between terminal devices. Examples of such direct communications include device-to-device, D2D, communication between terminal devices. Other examples of the direct communications include direct communications within a cluster (or group) of terminal devices; autonomous D2D communications in a cellular network; grid or group of local machines communicating with each other while performing certain tasks in co-operative way; and advanced cellular device acting as a gateway for a number of low-capability devices or machines to access the cellular network. One example of implementation possibilities of such direct communication services or applications in machine-type communications (MTC) is a cyber-physical system (CPS). In the CPS, interconnected devices (sensors, actuators, processors, microcontrollers, etc.) embedded in physical objects may communicate with one another or with communications devices, such as multimedia devices.

Direct communication links may refer to links in which two or more terminal devices transfer data between one another without routing the data through a serving access node 102. The terminal devices may each operate a control connection with the access node 102 but transfer data directly with at least one other terminal device. In another scheme, a serving terminal device is selected and only the serving terminal device operates the control connection with the serving access node. The other terminal device(s) then connect to the serving terminal device with a control connection and a data connection. A direct communication link 108 marked with a solid arrow in FIG. 1 as an example of the direct radio connection may be based on any radio technology such that the terminal devices 106A and 1068 involved in the direct communication may apply communication according to any of a plurality of radio access technologies. Terminal devices that have established a radio resource control (RRC) connection with the access node 102 may have their direct communication link(s) 108 controlled by the access node 102, as shown with dashed arrows in FIG. 1. For example, the access node may assign radio resources for the direct communication link 108.

Conventionally, the direct D2D communication links have been established on the basis of physical layer measurements based on received signal strength indicators (RSSI) or other physical layer parameters defined between two terminal devices. The aim has been to establish a D2D link between two terminal devices that are close to one another.

As said, file streaming, such as video transfer from the network to the user device, may occupy more than half of the communication capacity nowadays. Another increasingly popular service is social networking with a traffic volume contribution of almost 15%. The users of the social network may seek the data by leveraging their social relationships and ties. For example, a user may detect that a friend in the social network has viewed a music video. Then the user may more likely watch the same music video as well. Also the increased popularity of the social networks contributes to the increased traffic demands.

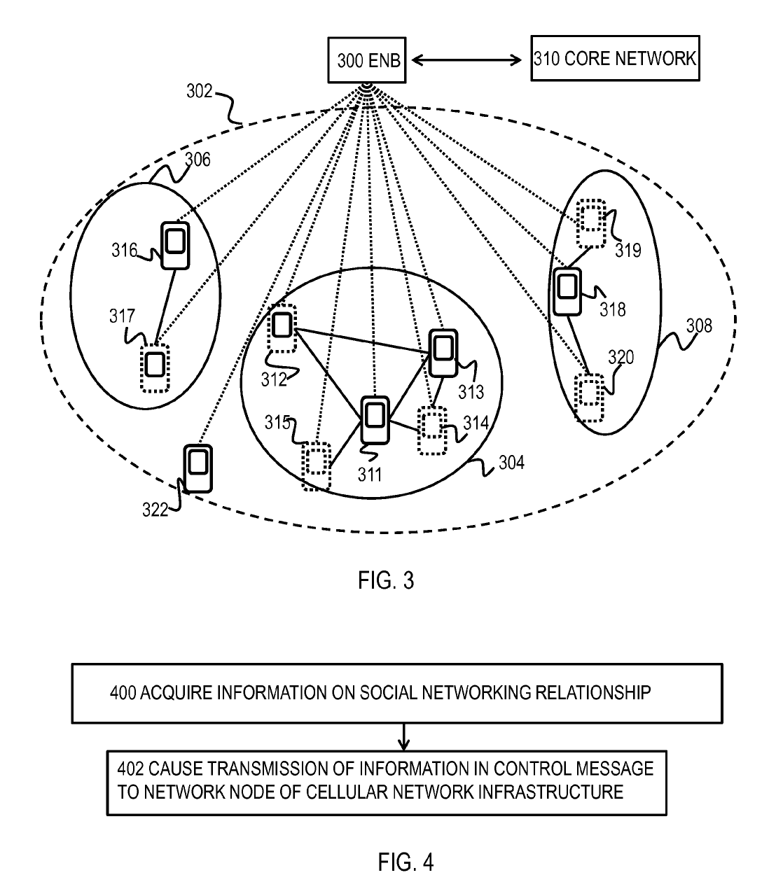

Accordingly, efficient data transfer is needed. It is proposed to utilize users' similarities in a social network community in utilization of radio connectivity of the terminal devices. Instead of, or in addition to the physical layer parameters, embodiments of the present invention employ application layer parameters in determining the radio connectivity of the terminal devices. As shown in FIGS. 2 and 3, a network node 300 may in step 200 arrange a set of terminal devices 311-322 into at least one cluster 304-308, and rules for setting the terminal devices may employ social networking parameters associated with users of the terminal devices. An embodiment for setting the cluster(s) is illustrated in the flow diagram of FIG. 2.

A network node 300 performing the method of FIG. 2 may be a serving access node, such as the access node 102 or 300 (eNB), or a controller of the cellular communication system, e.g. a controller other than the access node. The network node may be a small-cell access node, such as a access node providing coverage to a limited area, which may range from tens of meters within urban and in-building locations to a few km in a rural locations. These types of cells may be called micro-, pico-, or femto-cell, for example. In an embodiment, the network node may be home access node (HeNB). The network node 300 may be connected to the core network 310 for data communication to/from the Internet, for example. In embodiments where the network node 300 is not the access node, the network node 300 may be connected to the access node(s) through the core network 310 and/or through another network.

The terminal device 311-322 may be, e.g., a user device, user equipment (UE), user terminal (UT), computer (PC), laptop, tablet computer, phablet, cellular phone, mobile phone, communicator, smart phone, palm computer, or any other communication apparatus capable of accessing a network for data transfer. Each terminal device may be served by a access node and, optionally, also by one or more other access nodes.

The social network community (SNC) 302 may comprise a networking society established by social networking applications such as Facebook®, Twitter®, Digg®, or Instagram®, for example. These types of SNCs 302 comprise a large number of users (also known as members) who access the corresponding SNC 302 with the UE 311-320 and their user account(s) in each SNC. A member of the SNC 302 may need to identify him/herself to the SNC 302 by inputting credentials of his/her user account. A single user may be a member of multiple SNCs via respective user accounts. The user accounts of the same user may be associated with the same terminal device.

As said, in conventional communication, the traffic between communicating terminal devices is conventionally routed via the core network 310, thus increasing network load, data delay (latency) and access node resource utilization. In order to provide more “agile” means for communications, an embodiment of the invention utilizes networking relationship of users of the terminal devices to establish one or more clusters for which the same radio connectivity may be employed to optimize the utilization of the radio resources. Referring to FIG. 2, this may be carried out in a method executed in the above-described network node of a cellular communication system. The method may comprise: acquiring at least one information element representing application layer networking relationship of a first user account associated with a first terminal device with at least a second user account of a second terminal device, wherein both the first terminal device and the second terminal device are served by the same cell of the cellular communication system (block 200); determining, on the basis of the at least one information element, whether or not to assign the first terminal device and the second terminal device to the same cluster of terminal devices served by the same cell (block 202); and configuring, by the network node, the terminal devices of the same cluster to employ the same radio connectivity (block 204).

In an exemplifying FIG. 3, three clusters 304-308 are formed. Each cluster may comprise a plurality of terminal devices. The sizes of the clusters need not be the same. Each terminal device may belong up to one cluster at a time.

In an embodiment, using the same radio connectivity is defined such that the terminal devices of a cluster may be configured to carry out direct radio communication with each other over the D2D communication links that are marked with solid arrows between the terminal devices in FIG. 3. One of the terminal devices may be configured to operate as a serving terminal device in the D2D cluster, and the serving terminal device may be simultaneously connected to the serving access node 300 and to one or more other terminal devices of the same cluster. The serving terminal device may thus be considered to route a cellular connection between a served terminal device of the cluster and the serving access node 300. However, there may be terminal devices, e.g. the terminal device 322, that are not part of any cluster and communicate directly with the serving access node 300.

A technical effect of using the same radio connectivity may include improved offloading of traffic to D2D connections, for example, which improves the capacity of the access node.

In another embodiment, using the same radio connectivity is defined such that the terminal devices of the same cluster subscribe to the same radio broadcast service, e.g. an evolved multimedia broadcast multicast service (eMBMS) of the LTE networks. In this context, the terminal devices of the same cluster may be assigned with the same identifier (e.g. receiver identifier) of such a service. The identifier may comprise a multicast address which may be common to the terminal devices of the same cluster.

The description of FIG. 2 defines a process executed in a network node or a controller that is configured to set the cluster(s) in the cell. FIG. 4 illustrates a method for providing the information element(s) described in connection with FIG. 2. The method may be executed in one of the terminal devices or, generally, in an apparatus suitable for the terminal device. Such an apparatus may comprise the terminal devices or be comprised in the terminal device, e.g. a circuitry in the terminal device. Referring to FIG. 4, the method comprises: acquiring, in a first terminal device, at least one information element representing application layer networking relationship of a first user account associated with the first terminal device with at least a second user account associated with a second terminal device (block 400); and transmitting the at least one information element in a signaling message addressed to a network node of a network infrastructure of a cellular communication system (block 402).

In an embodiment, the networking relationship described above represents social networking relationship, such as communicating by using Twitter® sharing photos in Instagram®, tagging another user in Facebook®. The networking relationship may also be defined as an interest in the same content, such as a music video or sport broadcast.

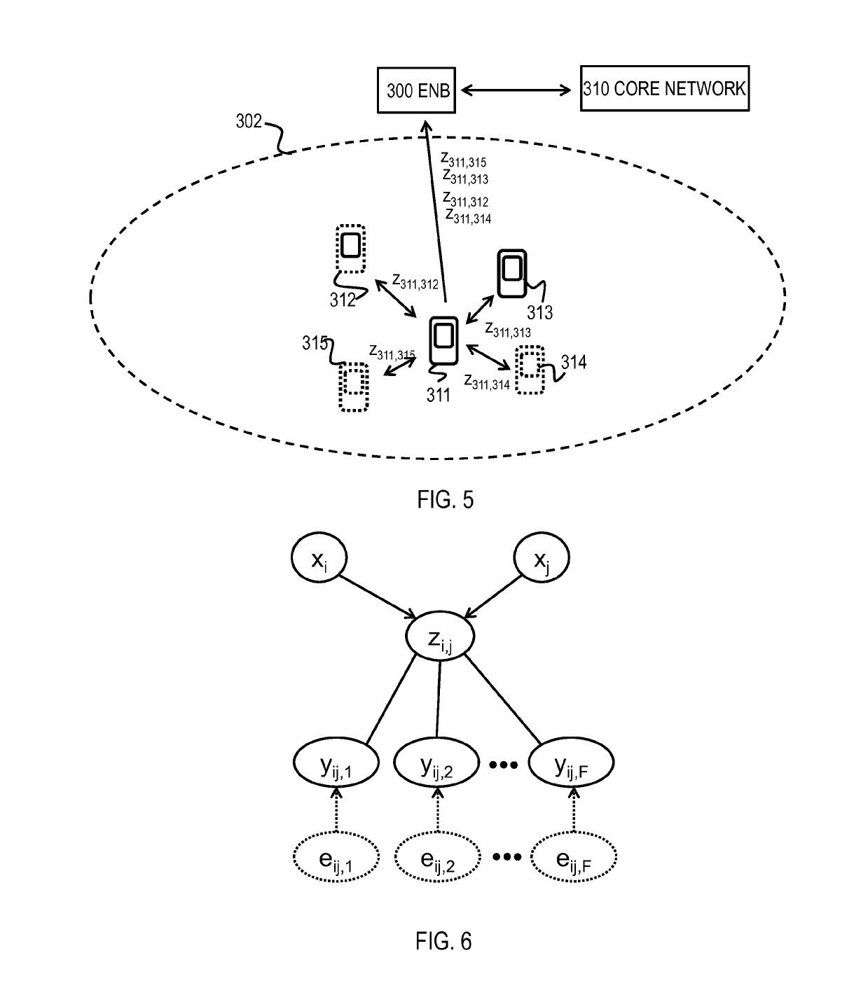

Let us now describe some embodiments of FIGS. 2 and 4. FIG. 5 illustrates a simplified view of FIG. 3, comprising only some of the terminal devices of FIG. 3 for simplicity. The arrows denoted by z_{i,j} represent the application layer networking relationship between the user of the terminal device 311 and users of the terminal devices 312 to 315, and the factor z_{i,j} represents a metric representing the application layer networking relationship. In an embodiment, the metric z_{i,j} may be proportional to the degree of the strength of the networking relationship between user i and user j. The metric z_{i,j} may represent an embodiment of the information element described above. The metric z_{i,j} may be estimated for a plurality of pairs of terminal devices within the same cell 302. In an embodiment, the terminal device 311 calculates the metrics z_{i,j} for a relationship with one or more users of respective one or more other terminal devices, wherein the other terminal device(s) may reside in the same cell 302, but not necessarily. In the scenario of FIG. 5, the user of the terminal device 311 may have a networking relationship with the users of the terminal devices 312 to 315 such that there is sufficient information available for calculating the respective metrics z_{311,312}, z_{311,313}, z_{311,314}, z_{311,315}. Upon computing the metrics, the terminal device may transmit the metrics to the controller using the metrics to form the cluster(s). Similarly, the other terminal devices may calculate the respective metrics x_{i,j} they can and transmit the metrics to the controller or to another controller. The controller(s) may then gather the metrics and store the metrics in a database accessible by the controller(s).

Let us now consider calculation of the metric z_{i,j}. Let z_{i,j} denote the strength of a networking tie between two users. The users may be defined through user account(s) of one or more social networking applications. The stronger is the tie between two user accounts, the more probable is that they transfer the same data (e.g. same multimedia streams). Therefore, terminal devices associated with user accounts that are calculated to have a strong tie may be assigned to the same cluster while terminal devices associated with user accounts that are calculated to have a weak tie may be assigned to different clusters or to no cluster at all. In the following, a learning model is described for determining the strength of the ties, z_{i,j}, from a given social networking application. The principles described below may be easily adapted to a scenario where multiple social networking applications are taken into account because the same procedure may be carried out with respect to each social networking application and the resulting values z_{i,j} for each application may be combined according to a desired combination logic, e.g. averaging.

FIG. 6 illustrates factors that affect the metric z_{i,j}. Let xᵢ and xⱼ be attribute vectors of users i and j, wherein each user is associated with a different terminal device. Each attribute vector may include one or more attributes from the user's profile of the social networking application. The attributes may comprise at least one of the following: age, gender, place of living, level of education, political view, religious view, hobbies, and interests. The strength of the networking relationship between the users i and j may be defined as a latent variable z_{i,j} that may be computed for multiple pairs of users. As shown in FIG. 6, the attribute vectors xᵢ and xⱼ may affect the strength of the tie between the users i and j.

Let us define y_{ij,f} as a vector of social networking interactions between the users i and j, wherein the social networking interaction may be defined as an activity by one of the users i,j in the social networking application that involves the other one of the users i,j. Such a social networking interaction may be user i tagging user j in a post published in the social networking application, writing on a wall of the user j in the social networking application, liking or commenting a post of the user j in the social networking application, selecting a post published by the user j in the social networking application, etc. y_{ij,f} may run from 1 to F where F is the total number of social networking interactions taken into account in the computation of the z_{i,j}. In an embodiment, the value of y_{ij,f} is binary in the sense that the value is 1 if a predetermined interaction has occurred and 0 if it the interaction has not occurred.

Parameters yᵢⱼ may represent factual social networking relationship between two users i and j. Additionally, at least one attribute xᵢ together with at least one attribute xⱼ may represent factual networking relationship between the users i and j from which interests in the same topics may be derived, for example.

As additional information, a vector e_{ij,f}=[e_{ij,f}¹ . . . e_{ij,f.}^{v}] may be defined for each interaction f where v is the number of interactions between the users i and j. The vector e_{ij,f} may represent the importance of user j for user i to carry out the interaction. For instance, if the user i has tagged user j with the assumption v=1, e_{ij,f.}¹ is the overall number of users that user i normally tags. In this context, the smaller value of e_{ij,f.}¹ may be interpreted as a stronger social tie between the users i and j.

Let us define a joint distribution of z and y by using the following factorization:

P(z_{i,j},y_{i,j}|xᵢ,yᵢ)=P(z_{i,j}|xᵢ,yⱼ)Π_{f=1}^{F} P(y_{ij,f}|z_{i,j}) (1)

where P( ) refers to a probability function. Let us further define a conditional probability function for the strength of the social tie z_{i,j} for given attributes xᵢ, zⱼ of user i and j:

P(zᵢⱼ|xᵢ, yⱼ)=N(w^{T}ξ(xᵢ, xⱼ), v) (2)

where N refers to a Gaussian distribution and ξ is a function of the attributes xᵢ, xⱼ and it may comprise a set of similarity values describing similarities of the attributes xᵢ, xⱼ. A similarity value may be calculated for each attribute comprised in the attribute vectors xᵢ, xⱼ. The attribute vectors may be modified to comprise only the same attributes of users i and j. For example, if user i has defined a political view but the user j has not, the political view may be removed from the attribute vector xᵢ in the computation of the ξ. w defines a weight vector which defines how the different similarity values are weighted. The values of the weight vector may be estimated or provided beforehand according to a determined criterion. The estimation may be based on examination of the effect of a given attribute on the probability of transferring a determined type of data.

Let us further define the following conditional probability:

P(y_{ij,f}=1|u_{ij,f})=1/(1+exp(−(ρ_{f}^{T}u_{ij,f}))) (3)

where u_{ij,f}=[e_{ij,f},zᵢⱼ]^{T} and ρ_{f}^{T}=[ρ_{f,1}¹ . . . ρ_{f,1}^{Θ}] where Θ is the number of interactions, ρ is a parameter that defines the shape of the probability distribution function, and it may be estimated by using training data, as described below. Given the variable z_{i,j}, all elements of y_{i,j} become independent of each other. All the variables xᵢ, xⱼ, y_{i,j}, and, in some embodiments, e_{ij,f} are known. Accordingly, the joint distribution of z_{i,j} and y_{i,j} may be written as:

P(z_{i,j},y_{i,j}|xᵢ,xⱼ,w,ρ)=Π_{(i,j)∈D}(P(z_{i,j}|xᵢ,xⱼ,w)Π_{f=1}^{F} P(y_{ij,f}|z_{i,j},ρ_{f})) (4)

After some mathematical rearrangement with the help of Equations (2) and (3), Equation (4) transforms into the following form:

$$P ( {z}_{i , j} , {y}_{i , j} \vert {x}_{i} , {x}_{j} , w , ρ ) ∝ {Π}_{( i , j ) ∈ D} ( {e}^{- \frac{1}{2 v } {( w {ξ}_{ij} - {z}_{i , j} )}^{2}} {\prod }_{f = 1}^{F} \frac{exp ( - ( {ρ}_{f}^{T} {u}_{ij , f} ) ( 1 - {y}_{ij , f} ) )}{1 + exp ( - ( {ρ}_{f}^{T} {u}_{ij , f} ) )} ) \qquad ( 5 )$$

where v represents variance from Equation (2) above and D a set of training data. Based on the above-described model, the social tie strength z_{i,j} may now be calculated by using training data set to estimate ŵ and \hat{ρ}. Accordingly, we get the following joint probability function:

P(z_{i,j},y_{i,j}w,ρ|xᵢ,xⱼ)=P(z_{i,j},y_{i,j}|xᵢ,xⱼ)P(w)P(ρ) (6)

In some embodiments, a probability function P(z_{i,j}|xᵢ,xⱼ) can be calculated from Equation (6) by integrating the probability function of Equation (6) over y_{i,j}.

Let us now elaborate implementation of the above-described expressions. The controller setting the cluster may be configured to gather a set of social tie strengths between the terminal devices in the same cell 302. The set of social tie strengths may be represented in the following matrix form:

$$Z = ( \begin{matrix}{z}_{1 , 1} & … & {z}_{1 , N} \\ ⋮ & ⋱ & ⋮ \\ {z}_{N , 1} & … & {z}_{N , N}\end{matrix} ) \qquad ( 7 )$$

where N is the number of terminal devices in the cell 302. Depending on the embodiment, the calculation of the elements of the matrix Z may be distributed to the terminal devices and/or the controller may compute the elements on the basis of the information received from the terminal devices, e.g. values of x and y, and information gathered from the training data, e.g. the weighting vector w and the distribution parameter ρ. The training data may be evaluated and the weighting vector and the distribution parameter computed in a separate process. Inputs to the evaluation may be the attributes xᵢ, the interactions y_{i,j} and, in some embodiments, the metric eᵢⱼ. The evaluation may comprise examination of the effect of each factor x, y and e on the strength of the social tie between users i and j. The strength of the social tie between may be represented by how much the user i and j download and/or upload the same data. Upon the examination, a weight w may be assigned to each attribute x and the interaction y on the basis of the determined effect on the strength of the social tie when the users share a common attribute (for x), or when the interaction is between the users (for y). The training data may be determined offline beforehand by using a set of real-life training data acquired from users of the social networking applications and statistics of the data they transfer via the social networking applications.

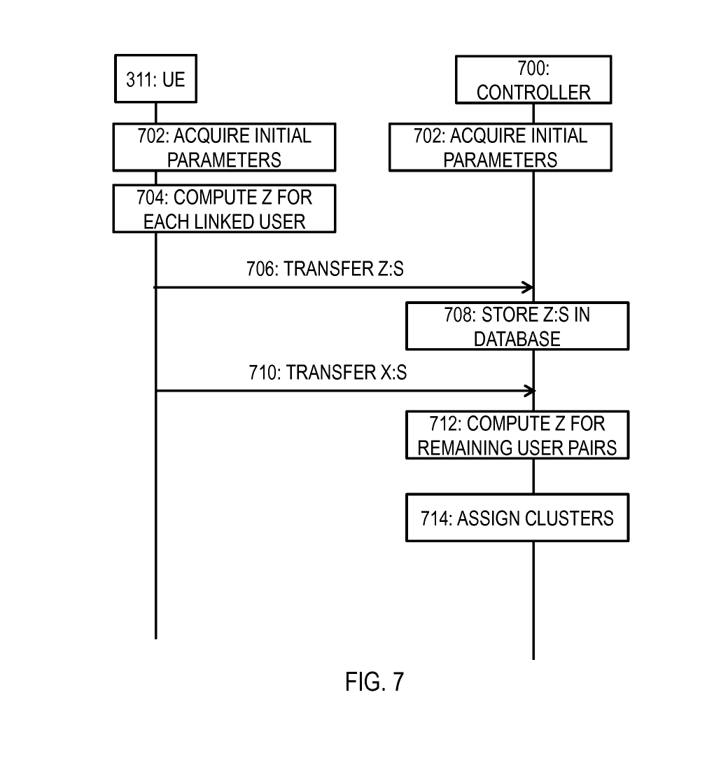

FIG. 7 illustrates an embodiment of a procedure for building the matrix Z or, generally, gathering information on the strength of the social ties between users of terminal devices served by the same cell. Upon acquiring the parameters w and ρ, e.g. on the basis of the training data, the parameters may be provided to the controller 700 and/or the terminal devices (blocks 702) for the computation of the information elements representing the application layer networking relationship, e.g. the value of z_{i,j}. A terminal device 311 computing the information element z_{i,j} in block 704 may use input information from the social networking application to determine the values xᵢ, xⱼ, and y_{ij,f} for every other user with which the user of the terminal device 311 has a linked user account in the social networking application. In typical social networking applications, each user is able to gather the attributes xⱼ of the other users, and the interactions between the user of the terminal device and the other users in the user's social network are also available. Accordingly, the terminal device 311 may use the available information to compute the estimates of the z_{i,j} for every other user in the user's social network. Upon computing the information elements z, the terminal device may transmit the information elements to the controller 700 in a signaling message or a control message (step 706).

In an embodiment, the signaling message is a link layer control message. In an embodiment, the signaling message is a radio resource control message. In an embodiment, the signaling message is a network layer control message. In an embodiment, the signaling message is a message transmitted as on a protocol layer below the application layer.

Upon receiving the information elements in step 706, the controller 700 may store the information elements in a database (block 708). The database may store a record for each terminal device of the same cell. The record may store an identifier of the terminal device, e.g. an International Mobile Subscriber Identity (IMSI) or an International Mobile Equipment Identity (IMEI). The record may store an identifier of the user of the terminal device, e.g. a user name of one or more social networking applications or an e-mail address. The record may be updated if the user changes his/her new terminal device. The record may store the strength of the social tie (z) between the user and other users of other terminal devices, as calculated according to embodiments described herein. A similar database may be maintained for other cells, obviously.

Other terminal devices 312 to 322 in the cell 302 may transmit the information elements z in the above-described manner for other users in the respective social networks. The controller may then gather the information elements and construct the matrix Z. The controller may be able to construct the matrix Z only partially because not all the terminal devices are necessarily linked to each other via the inter-linked user accounts of the social networking application. Let us describe how to complete the matrix in the following.

Each terminal device may transmit to the controller the parameters x used in the computation of the strength of the social tie (block 710). The parameters may be transmitted in any one of the above-described signaling messages. When computing the strength of the social tie between two users that are not linked via the social networking application, the controller 700 may take into account profile similarities represented by the similarities between the attributes, e.g. by the values of ξ. On the basis of the training data, this type of mapping from the similarities of the user profiles into the strength of the social tie is possible by determining the effect of the similarity of each attribute x on the probability that the users upload and/or download the same data. In this manner, the controller may complete the matrix Z in block 712 by using the information received in step 710 completed.

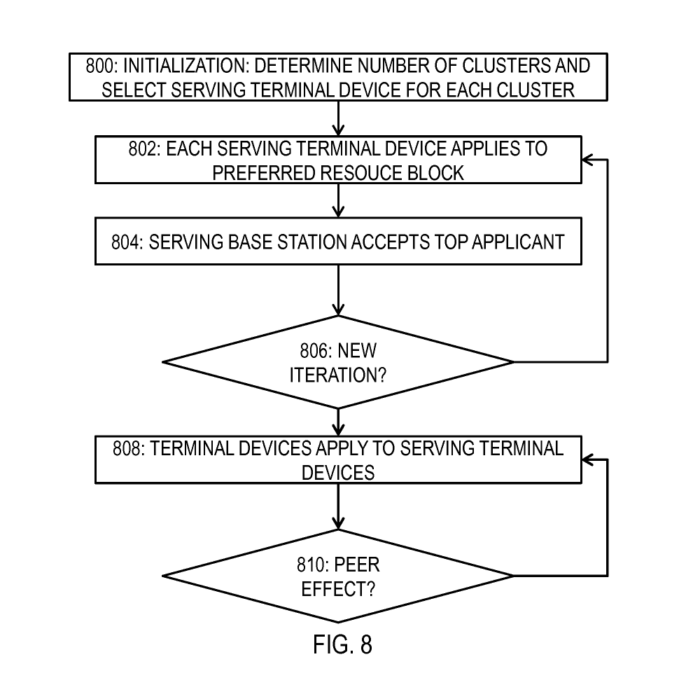

Now that the controller 700 has the information on the estimated strength of the social ties between each pair of terminal devices in the cell, the controller 700 may use the information to set up one or more clusters (block 714). FIG. 8 illustrates an embodiment of block 202 or 714 in the context where the clusters are configured to establish direct D2D communication links. Referring to FIG. 8, the controller 700 may execute block 800 by determining the number of clusters and selecting a serving terminal device for each cluster. The clusters may be formed on the basis of total social influence of the users of the terminal devices in the cell 302. The total social influence for user i may be defined as Iᵢ=Σⱼz_{i,j}, i.e. as a sum of strengths of the social ties of the user i with other users of the other terminal devices in the cell 302, as determined from the matrix Z. If the total social influence of the user i is over a determined threshold, the terminal device of the user i may be selected as a candidate for a serving terminal device in a cluster. The number of the clusters may be defined by the number of terminal devices having users with the total social influence above the threshold. In case there is a determined cap for the number of clusters and the number of candidate terminal devices exceeds the cap, a subset the terminal devices having the highest total social influence may be selected. The controller may output the information on the selected serving terminal devices to the serving access node 300 and the terminal devices, e.g. to the serving terminal devices and the other terminal devices in the cell.

Thereafter, the serving access node 300 may initiate a resource matching process in which the serving access node allocates radio resource blocks to the serving terminal devices for use in the D2D links. The process may be considered as a matchmaking process in which both the serving terminal devices and the serving access node can decide on the resource allocation. A radio resource block may be defined as a time-frequency resource which may be assigned in a static or semi-static manner to a serving terminal device. The radio resource block may be defined as a frequency band with defined bandwidth, e.g. in terms of number of sub-carriers of a multicarrier radio signal as used in the LTE. According to the embodiment of FIG. 8, each terminal device may apply for a resource block (block 802), and the access node 300 may assign the resource blocks by responding to the requests (804). In case two serving terminal devices request for the same resource block, the serving access node may assign the resource block to the serving terminal device with the highest total social influence. The terminal device that did not get the resource block, may request for another resource block in the next iteration (block 806). After one or more iterations, the resource blocks are assigned to the serving terminal devices.

When the resource blocks are allocated, the other terminal devices may be attached to the clusters. In an embodiment, the controller or the serving access node may assign the terminal devices to the clusters on the basis of the strength of their social relationships with the serving terminal devices. If a metric z between user of a first terminal device and a user of a serving terminal device is above a determined threshold, the access node may assign the first terminal device to the same cluster with the serving terminal device. In another embodiment, the terminal devices may request to join a desired cluster. Each serving terminal device may advertise the availability of the D2D link, and each terminal device may store identifiers (e.g. a cellular radio network temporary identifier, C-RNTI) of at least those other terminal devices with which the user has a social networking link via at least one social networking application. Accordingly, the terminal device may detect, if a terminal device associated with a contact from its user's social network operates as the serving terminal device. The terminal device may then choose to request for a connection in the cluster of such a serving terminal device. The decision of whether or not to accept the request may be made by the serving access node or the serving terminal device, depending on the embodiment. Accordingly, the request may be transmitted to the corresponding entity.

In block 810, peer effects are handled. The peer effects may comprise a terminal device being switched from one cluster to another on the basis of the changed social ties, creation of a new cluster, or removal of a cluster, for example. As a consequence, at least some of the terminal devices may be reallocated to another cluster.

The cluster may be considered as a social cluster in the sense that the cluster is formed on the basis of the social ties between users of the terminal devices. We use the term social to indicate that the social relationships of users affect the formation of the cluster in which the same radio connectivity is used. Due to the social effects, the following observations may be made: 1) a terminal device is encouraged by its user's friends to join the same cluster in order to form socially stronger clusters, 2) serving terminal devices with larger clusters (more terminal devices) may acquire higher quality links or higher bandwidth, and 3) to improve offloading of traffic from a base-station-to-terminal-device interface to terminal-to-terminal interface, serving access nodes may have an incentive to encourage terminal devices, with at least one friend as a serving terminal device, to use D2D links.

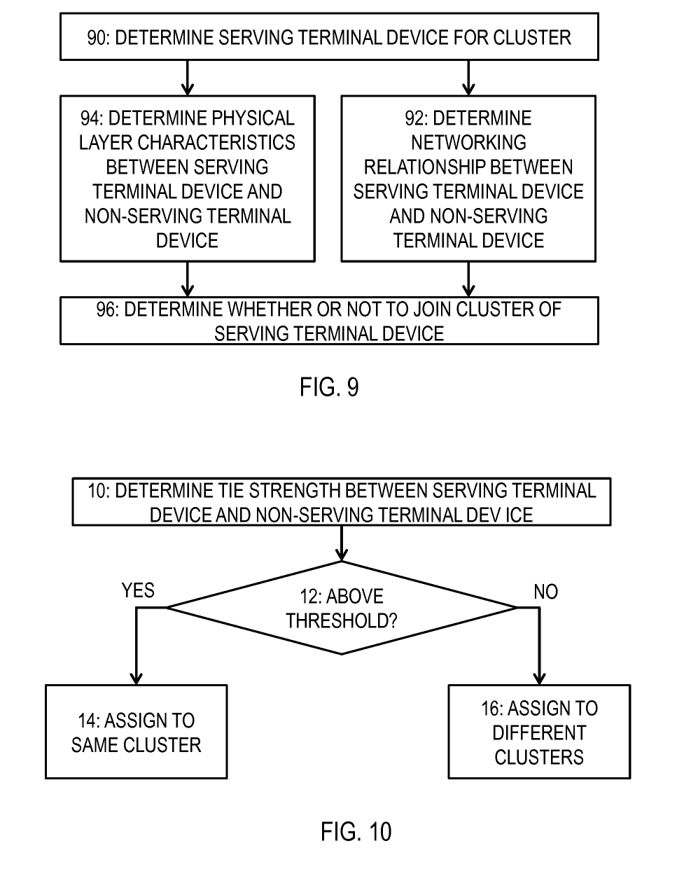

Above, the terminal devices join the cluster mainly on the basis of the application layer social networking relationship with the serving terminal devices. In some embodiments, physical layer characteristics are used as a further input to the selection of a cluster for a terminal device. In an embodiment illustrated in FIG. 9, the terminal device may first determine a serving terminal device of a cluster (block 90) and, then, carry out physical layer measurements (block 94) with respect to the serving terminal devices. The terminal device may additionally determine the networking relationship towards the serving terminal device of the cluster (block 92). Then, the terminal device may use the determined networking relationship (e.g. the value of z between the terminal device and the serving terminal device) and measurement values of the physical layer measurements as the input in determining whether or not to join the cluster of the serving terminal device (block 906). For example, a received signal strength indicator (RSSI) which is a measure of reception strength of a signal received from a serving terminal device may be used as the input. The RSSI may be defined as a measure of a quality of a radio link between the terminal device and the serving terminal device. In an embodiment, if the RSSI measured from a signal received from the serving terminal device is above a threshold, the terminal device may join the cluster of the serving terminal device. Otherwise, the terminal device may need join another cluster or connect directly to the serving access node. The signal from which the RSSI is measured, may be a reference signal transmitted by the serving terminal device.

In another embodiment illustrated in FIG. 10, the serving access node or the controller 700 may assign the non-serving terminal devices to the clusters, e.g. on the basis of the tie strength values determined in block 10. For example, a first terminal device may be configured to establish the direct D2D radio connection with a serving terminal device (block 14), if the at least one information element indicates in block 12 a strong networking relationship between a user account of the first terminal device and a user account of the serving terminal device. On the other hand, the first terminal device may be configured to connect to the serving access node operating the cell or to another serving terminal device (block 16), if the at least one information element indicates in block 12 a weak networking relationship between the user accounts.

In the embodiment where the same radio connectivity employed by the terminal devices of the same cluster is the common identifier in a multicast service, the controller 700 or the serving access node 300 may assign the terminal devices in the clusters.

In the following, examples of apparatuses suitable for carrying out embodiments described above in relation to FIGS. 2 to 10 are presented.

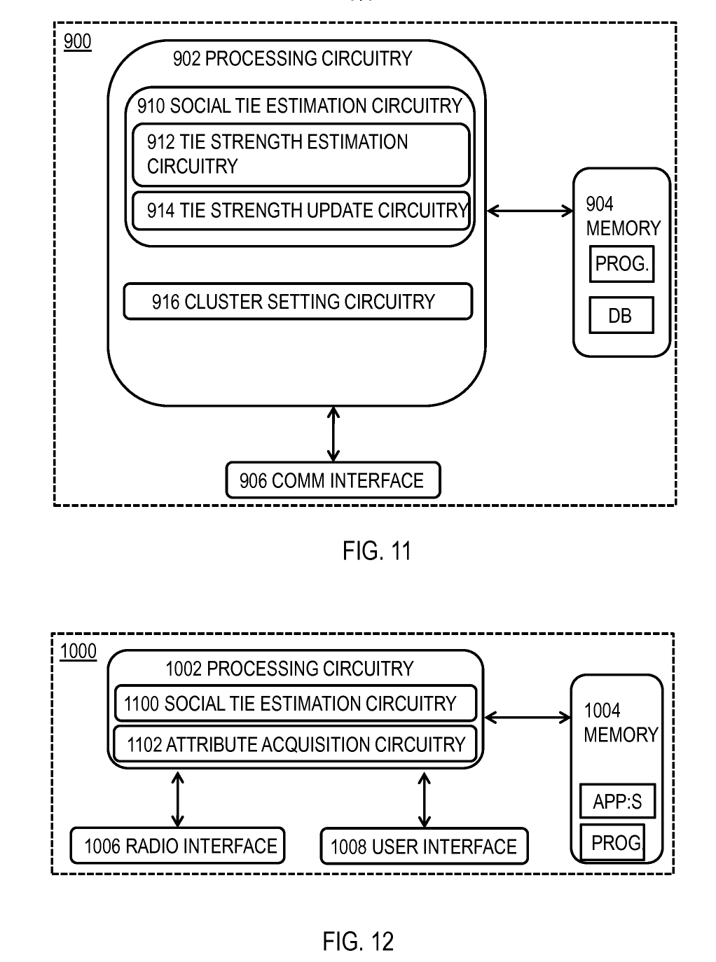

FIG. 11 illustrates an apparatus 900 suitable for the controller 700 using the information elements representing the application layer social networking relationships amongst users of terminal devices served by the same cell to establish the clusters. The controller may be a stand-alone controller connected to a network infrastructure of a cellular communication system. In some embodiments, the controller may be comprised in the network infrastructure. In an embodiment, the controller is comprised in the access node operating the cell.

The apparatus may comprise a processing circuitry 902 comprising at least one processor, and it may further comprise a memory 904 storing a computer program code (FROG), wherein the computer program code causes the processing circuitry to carry out the above-described functions of the controller, e.g. execution of the process of FIG. 2. The memory 904 may further store a database (DB) storing the above-described information elements representing the social networking relationship. The apparatus 900 may further comprise a communication interface 906 comprising a communication circuitry configured to establish a communication connection within the network infrastructure. The communication interface may comprise hardware and, in some embodiments, software to establish a communication connection according to one or more communication protocols. The communication protocols may include internet protocol (IP) and/or Ethernet.

The memory 904 may be implemented using any suitable data storage technology, such as semiconductor based memory devices, flash memory, magnetic memory devices and systems, optical memory devices and systems, fixed memory and removable memory.

The processing circuitry 902 may comprise a social tie estimation circuitry 910 configured to estimate the application layer social networking relationship of users of the terminal devices in one or more social networking applications. The social tie estimation circuitry 910 may comprise a social tie strength estimation circuitry 912 configured to estimate the strength of the social ties between groups of two users using different terminal devices. In an embodiment, the social tie strength estimation circuitry 912 is configured to estimate the parameter z_{i,j} described above on the basis of the information xᵢ, xⱼ, y_{ij,f} received from the terminal devices and or acquired from another source, e.g. from a server computer of the social networking application. The social tie estimation circuitry 910 may further comprise a social tie strength update circuitry 914 configured to update a database (DB) storing the information elements representing the social networking relationships, as new information on the social networking relationships is acquired. It may add the outputs of the social tie strength estimation circuitry 912 to the database. In embodiments where the terminal devices estimate the social tie strength and the apparatus 900 receives the social tie strength values from the terminal devices through the communication interface 906, the social tie strength update circuitry may update the database.

The processing circuitry 902 may further comprise a cluster setting circuitry 916 configured to form the one or more clusters of terminal devices in the cell on the basis of the acquired information on the application layer social networking relationship. The cluster(s) may be formed according to any one of the above-described embodiments. In an embodiment, forming a cluster may comprise selecting a serving terminal device to provide D2D communication links within the cluster. The cluster setting circuitry 916 may output the information on the formed cluster(s) to the communication interface such that the information is addressed to the serving access node and/or the terminal device(s) in the formed cluster(s).

FIG. 12 illustrates an apparatus 1000 according to another embodiment. The apparatus 1000 may comprise the terminal device of a cellular communication system, e.g. a user equipment (UE), a user terminal (UT), a computer (PC), a laptop, a tablet computer, a cellular phone, a mobile phone, a communicator, a smart phone, a palm computer, or any other communication apparatus. Alternatively, the apparatus 1000 is comprised in such a terminal device. Further, the apparatus 1000 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 1000 may be, may comprise, or may be comprised in a mobile phone, such as one of the terminal devices 311-322.

The apparatus may comprise a processing circuitry 1002 comprising at least one processor, and it may further comprise a memory 1004 storing a computer program code (FROG), wherein the computer program code causes the processing circuitry to carry out the above-described functions of the terminal device, e.g. execution of the process of FIG. 4. The memory 1004 may further store one or more social networking applications (APP:S) that are realized in the form of one or more computer program applications. The apparatus 900 may further comprise a communication interface 1006 comprising a communication circuitry configured to establish a communication connection with a cellular communication system, e.g. with one or more access nodes. The communication interface 1006 may be further configured to establish direct D2D communication links with another terminal device. The communication interface 1006 may comprise hardware and, in some embodiments, software to establish a communication connection according to one or more communication protocols. The communication protocols may include internet protocol (IP) and/or Ethernet.

The memory 904 may be implemented using any suitable data storage technology, such as semiconductor based memory devices, flash memory, magnetic memory devices and systems, optical memory devices and systems, fixed memory and removable memory.

The apparatus 1000 may further comprise a user interface 1008 configured to receive information input by a user through a user input system of the user interface 1008 and to output information to the user through a display screen and/or audio speaker(s).

The processing circuitry 1002 may comprise a social tie estimation circuitry 1100 that may comprise the above-described social tie strength estimation circuitry 912. The processing circuitry 1002 may comprise an attribute acquisition circuitry 1102 configured to acquire at least some of the above-described attributes xᵢ, xⱼ, yᵢⱼ from one or more social networking applications installed to the apparatus and to cause transmission of the attributes to the controller for the computation of the social tie strength metrics z_{i,j}. As described above, the computation of the metrics z_{i,j} may be distributed to the controller and the terminal devices but the computation may be centralized to the controller only. In such a case, the terminal devices may transmit the attributes yᵢⱼ to the controller in the signaling message.

The sub-circuitries 912, 914, 916 and 1100, 1102 of the respective processing circuitries 902, 1002 may be considered as computer program modules executed by the same physical processor(s) or as physically separate circuitries, depending on the implementation.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software (computer program codes or portions thereof), and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described above may also be carried out in the form of a computer process defined by a computer program or portions thereof. The computer program may be in source code form, object code form, or in some intermediate form, and it may be stored in some sort of carrier, which may be any entity or device capable of carrying the program. For example, the computer program may be stored on a computer program (distribution) medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
acquiring, in a controller apparatus of a cellular communication system, at least one information element representing application layer networking relationship of a first user account associated with a first terminal device with at least a second user account of a second terminal device, wherein both the first terminal device and the second terminal device are served by the same cell of the cellular communication system;
determining, in the controller apparatus on the basis of the at least one information element, whether or not to assign the first terminal device and the second terminal device to the same cluster of terminal devices served by the same cell, wherein the terminal devices of the same cluster are configured to employ the same radio connectivity.

2-12. (canceled)

13. A method comprising:
acquiring, in a first terminal device, at least one information element representing application layer networking relationship of a first user account associated with the first terminal device with at least a second user account of a second terminal device; and
transmitting the at least one information element in a signaling message addressed to a controller apparatus of a network infrastructure of a cellular communication system.

14-16. (canceled)

17. An apparatus, comprising:
at least one processor and at least one memory including a computer program code, wherein the at least one memory and the computer program code are configured, with the at least one processor, to cause the apparatus to perform operations comprising:
acquiring at least one information element representing application layer networking relationship of a first user account associated with a first terminal device with at least a second user account of a second terminal device, wherein both the first terminal device and the second terminal device are served by the same cell of a cellular communication system;
determining, on the basis of the at least one information element, whether or not to assign the first terminal device and the second terminal device to the same cluster of terminal devices served by the same cell, wherein the terminal devices of the same cluster are configured to employ the same radio connectivity.

18. The apparatus of claim 17, wherein the at least one information element represents a strength of a networking relationship between the first user account and the second user account.

19. The apparatus of claim 17, wherein upon determining to assign the first terminal device and the second terminal device to the same cluster, the at least one memory and the computer program code are configured, with the at least one processor, to cause the apparatus to configure a direct device-to-device radio connection between the first terminal device and the second terminal device on the basis of the at least one information element.

20. The apparatus of claim 19, wherein the at least one memory and the computer program code are configured, with the at least one processor, to cause the apparatus to perform the following when performing the configuration of the direct device-to-device connection:
configuring the first terminal device to establish the direct device-to-device radio connection with the second terminal device, if the at least one information element indicates a strong networking relationship between the first user account and the second user account, wherein data is transferred between the first terminal device and the second terminal device over the direct device-to-device radio connection; and
configuring the first terminal device to connect to a access node operating the cell, if the at least one information element indicates a weak networking relationship between the first user account and the second user account, wherein data is transferred to the first terminal device directly from the access node.

21. The apparatus of claim 19, wherein the at least one memory and the computer program code are configured, with the at least one processor, to cause the apparatus to configure the direct device-to-device radio connection between the first terminal device and the second terminal device further on the basis of at least one physical layer metric representing physical layer relationship between the first terminal device and the second terminal device.

22. The apparatus of claim 17, wherein the at least one memory and the computer program code are configured, with the at least one processor, to cause the apparatus to:
acquire said at least one information element for a plurality of terminal devices served by the same cell;
select, on the basis of said information elements, a subset of the plurality of terminal devices to become serving terminal devices for direct device-to-device radio connections, wherein one serving terminal device is selected per cluster, and wherein a serving terminal device provides radio connectivity between a non-serving terminal device and a access node operating the cell.

23. The apparatus of claim 22, wherein the at least one information element indicates a strength social networking influence amongst user accounts of the plurality of terminal devices.

24. The apparatus of claim 17, wherein the same radio connectivity employed by the terminal device of the same cluster refers to a common multicast address of a multicast service provided by a access node operating the cell.

25. The apparatus of claim 17, wherein the at least one information element is computed by employing at least one of a number of social networking interactions between the first user account and the second user account and the number of same or substantially similar user attributes in user profiles of the first user account and the second user account.

26. The apparatus of claim 17, the at least one memory and the computer program code are configured, with the at least one processor, to cause the apparatus to estimate the at least one information element by employing factual networking relationship between the first user account and the second user account and, additionally, a statistical model mapping the factual networking relationship to a value representing the strength of the networking relationship.

27. The apparatus of claim 26, wherein the statistical model is constructed by employing training data.

28. The apparatus of claim 26, wherein the factual networking relationship is received from at least one of the terminal devices served by the cell.

29. An apparatus, comprising:
at least one processor and at least one memory including a computer program code, wherein the at least one memory and the computer program code are configured, with the at least one processor, to cause the apparatus to perform operations comprising:
acquiring at least one information element representing application layer networking relationship of a first user account associated with a first terminal device with at least a second user account of a second terminal device; and
causing transmission of the at least one information element in a signaling message addressed to a controller apparatus of a network infrastructure of a cellular communication system.

30. The apparatus of claim 29, wherein the at least one information element represents a strength of a networking relationship between the first user account and the second user account.

31. The apparatus of claim 29, wherein the at least one memory and the computer program code are configured, with the at least one processor, to cause the apparatus to compute the at least one information element by employing at least one of a number of social networking interactions between the first user account and the second user account and the number of same or substantially similar user attributes in user profiles of the first user account and the second user account.

32. The apparatus of claim 29, wherein the at least one memory and the computer program code are configured, with the at least one processor, to cause the apparatus to estimate the at least one information element by employing factual networking relationship between the first user account and the second user account and, additionally, a statistical model mapping the factual networking relationship to a value representing the strength of the networking relationship.

33-35. (canceled)
